(19) United States
(12) Patent Application Publication
(10) Pub. No.: US 2011/0185690 A1
(43) Pub. Date: Aug. 4, 2011

(54) SIC/GLASS-CERAMIC COMPOSITE FILTER

(75) Inventors: Cecile Jousseaume, Paris (FR); Carine Dien-Barataud, Isle (FR); Gilles Querel, Compiegne (FR); Caroline Tardivat, Aix-en-Provence (FR); Sebastien Remi Bardon, Paris (FR)

(73) Assignee: Saint-Gobain Centre De Rech. Et D'Etudes Europeen, Courbevoie (FR)

(21) Appl. No.: 12/993,701

(22) PCT Filed: May 19, 2009
(86) PCT No.: PCT/FR09/50931

§ 371 Date: Apr. 21, 2011

(30) Foreign Application Priority Data
May 22, 2008 (FR) 0853341

(51) Int. Cl. B01D 39/20

(52) U.S. Cl. 55/385.3; 55/523

(57) ABSTRACT

The invention relates to a filter of which the filtering portion is made from an inorganic material comprising grains of SiC bonded by a vitroceramic phase, to form a porous structure of which the apparent porosity is between 20 and 70%, said vitroceramic bonding phase comprising at least the following components, in molar percentage of the total oxides present in said phase:
SiO₂: 30% to 80%
Al₂O₃: 5% to 45%
MO: 10% to 45%, where MO is an oxide of a divalent cation or the sum of the oxides of the divalent cations present in said vitroceramic phase, M preferably being selected from Ca, Ba, Mg or Sr, said vitroceramic phase having a volume percentage of residual vitreous phase lower than 20%.

The invention relates to the field of filters. More particularly, the present invention relates to the field of porous materials for obtaining honeycomb structures. Such structures are used in particular as catalyst supports or as particulate filters in systems for treating motor vehicle gases in an exhaust line of an internal combustion engine. In a manner known per se, such systems serve to remove the pollutants such as gaseous and/or solid pollutants, in particular the soot produced by the combustion of a gasoline or diesel fuel.

Structures for filtering the soot contained in the exhaust gases of an internal combustion engine are well known in the prior art. These structures have a honeycomb structure, one side of the structure for admitting the exhaust gases to be filtered, and the other side for discharging the filtered exhaust gases. Between the intake and discharge sides, the structure comprises a set of adjacent conduits with mutually parallel axes, separated by porous filtration walls, said conduits being blocked at one or the other of their ends to bound intake chambers opening at the intake side and discharge chambers opening at the discharge side. For proper tightness, the peripheral portion of the structure may be surrounded by a coating cement. The channels are alternately blocked in an order such that the exhaust gases, when passing through the honeycomb body, are forced to cross the side walls of the intake channels to reach the discharge channels. In this way, the particulates or soot are deposited and accumulate on the porous walls of the filter body. In general, the filter bodies are based on a porous ceramic material, for example cordierite, silicon carbide or aluminum titanate.

In a manner known per se, during its use, a particulate filter is subject to a succession of filtration (soot accumulation) and regeneration (soot removal) phases. During the filtration phases, the soot particulates emitted by the engine are retained by and deposit inside the filter. During the regeneration phases, the soot particulates are burned inside the filter, so as to restore its filtration properties. The porous structure is accordingly subjected to intense thermomechanical stresses, which can cause microcracks that are liable, over time, to cause a severe loss of the filtration capacity of the unit, or even its complete deactivation. This process is observed in particular on large-diameter or very long monolithic filters.

To solve these problems and to increase the service life of the filters, more complex filtration structures were proposed more recently, combining several honeycomb monolithic elements or segments, in a filter block. The elements are usually joined together by adhesive using a ceramic cement, referred to below as joint cement. Examples of such filtering structures are described for example in patent applications EP 816 065, EP 1 142 619, EP 1 455 923, WO 2004/090294, or even WO 2005/063462. The soot filters as previously described are mainly used on a large scale in pollution control devices for the exhaust gases of a diesel internal combustion engine in motor vehicles or trucks, or in a stationary system.

At the present time, despite the improvements made, the filtration structures are not yet fully reliable throughout the service life of the motor vehicle. Thus, rather frequently for certain materials, which have relatively low mechanical strength, like cordierite, radial cracks may appear during a poorly controlled regeneration, or even during a spontaneous regeneration in the filter. During such uncontrolled phases, the local temperature of the filter may rise above 1000° C., with high spatial temperature non-uniformity, leading to the appearance of cracks, which have a variable impact on the integrity and filtration capacity of the filter. In particular, experience has shown that in the most serious cases, large radial cracks may appear, possibly encompassing the entire filter.

While the use of recrystallized SiC (R-SiC), combined with filter segmentation techniques, has significantly improved the thermomechanical strength of filters, and thereby lengthened filter service life while sharply lowering the risks of cracking, the production of such filters incurs substantial extra costs in comparison with cordierite filters for example.

The extra production cost of a R-SiC particulate filter is currently mainly due to the energy consumed and the equipment required to reach the sintering temperature of recrystallized SiC, usually between 2100 and 2300° C. By comparison, the costs associated with other production parameters, such as the cost of raw materials, or of the extrusion process, are minimal.

It is therefore the object of the present invention to provide a filter of which the production cost is lowered, but which has thermomechanical strength properties at least comparable to those observed with a R-SiC filter. The investigations conducted by the applicant and reported below have accordingly served to obtain composite SiC-vitroceramic filters for achieving such an objective.

In its most general form, the invention relates to a filter of which the filtering portion is made from an inorganic material comprising grains of SiC bonded by a vitroceramic phase, to form a porous structure of which the apparent porosity is between 20 and 70%, said vitroceramic bonding phase comprising at least the following components, in molar percentage of the total oxides present in said phase:
SiO₂: 30% to 80%
Al₂O₃: 5% to 45%
MO: 10% to 45%,
where MO is an oxide of a divalent cation or the sum of the oxides of the divalent cations present in said vitroceramic phase, M preferably being selected from Ca, Ba, Mg or Sr, said vitroceramic phase having a volume percentage of residual vitreous phase lower than 20%.

Preferably, M is at least one divalent cation selected from Ca, Ba, Mg.

Preferably, the vitroceramic phase comprises between 40 and 60 molar % of SiO₂, preferably between 45 and 55 molar % of SiO₂.

According to a possible embodiment, the vitroceramic phase comprises between 15 and 30 molar % of Al₂O₃.

While remaining within the scope of the invention, the vitroceramic phase may further comprise between 5 and 20 molar % of oxide A₂O in which A is an alkali or the sum of the alkalis present in said phase, the alkali or alkalis being selected from Na, K or preferably Cs.

The vitroceramic phase may further comprise between 1 and 5 molar % of boron oxide.

In general, the mass ratio of the vitroceramic phase to the SiC phase in the porous material is between 10/90 and 40/60, preferably between 20/80 and 30/70.

For example, the vitroceramic phase comprises at least the following components, in molar percentage of the total oxides present in said phase:
SiO₂: 40% to 70%
Al₂O₃: 10% to 30%
MgO: 15 to 35%.

According to a possible embodiment of the invention, the vitroceramic phase crystallizes in the cordierite structure, said phase comprising the following components, in molar % of the oxides:
SiO₂: 40% to 55%
Al₂O₃: 20% to 30%
MgO: 18 to 30%
A₂O: 5 to 20%, where A is a monovalent cation, preferably Cs
B₂O₃: 1 to 3%.

According to another embodiment, the vitroceramic phase crystallizes in the anorthite-celsian structure, said phase comprising the following components, in molar % of the oxides:
SiO₂: 40% to 55%
Al₂O₃: 15% to 30%
CaO: 5 to 15%
MO: 5 to 20%, where M=Ba and/or Sr, preferably M=Ba
B₂O₃: 1 to 5%.

The invention relates in particular to a honeycomb particulate filter having a structure as previously described, adapted for filtering the exhaust gases of a motor vehicle. Such a filter may comprise a single monolithic element or may be obtained by the combination, by bonding with a joint cement, of a plurality of honeycomb monolithic elements.

The invention and its advantages will be better understood from a reading of the examples that follow. It is obvious that these examples must not be considered, from any one of the aspects described, as limiting the present invention.

### EXAMPLE 1

### R-SiC Structure Alone

According to this first example, rods of recrystallized silicon carbide were synthesized by conventional techniques already well known in the field and described for example in patent application EP 1 142 619 A1. In a first step, a mixture of silicon carbide particles having a purity above 98% was first prepared in a mixer, according to the method for fabricating a R-SiC structure described in application WO 1994/22556. The mixture was obtained from a coarse-grained fraction of SiC particles (75 wt %) of which the median particle diameter was higher than 10 microns, and a fine grain size fraction (25 wt %) of which the median particle size was lower than 1 micron. In the context of the present invention, the median diameter means the particle diameter that equally divides the population by weight. 7% by weight of a pore-forming agent of the polyethylene type and 5% by weight of an organic binder of the cellulose derivative type, with respect to their total weight, were added to the portion of SiC particles.

Water was also added in the amount of 20% by weight of the sum of the preceding components, and the mixture was blended to a uniform slurry having sufficient plasticity for the formation of rods or for extrusion through a die having a honeycomb structure.

After extrusion, the honeycomb monoliths and the recrystallized SiC rods were obtained after firing under inert atmosphere at a temperature of 2200° C. In detail, the optimal experimental conditions are the following: temperature rise of 20° C./hour to 2200° C., then temperature holding for six hours at 2200° C.

### EXAMPLE 2

### According to the Invention

In a first step, a first glass composition was prepared by melting a mixture of precursors, in suitable proportions, placed in platinum crucibles in an updraft kiln. After the complete fusion of the mixture, the glass was quenched in water to obtain a granulation.

The analysis shows that the glass phase thus obtained has the following composition, in molar percentage of the oxides:

TABLE 1

| SiO₂ | Fe₂O₃ | Al₂O₃ | CaO | MgO | Na₂O | Cs₂O | B₂O₃ | P₂O₅ | Total |
|---|---|---|---|---|---|---|---|---|---|
| 47.53 | 0.01 | 24.55 | 0.80 | 21.40 | 0.19 | 3.48 | 1.60 | 0.43 | 100.00 |

An annealing of this vitreous phase at a temperature of 1050° C. served to confirm that it was possible to obtain, from this composition, a vitroceramic phase of which the crystalline phase is of the cordierite type (MgO—Al₂O₃—SiO₂ system).

In a second step, this glass composition was used, after fine grinding, to obtain extruded rods and honeycomb monoliths of the SiC-vitroceramic type according to the invention. More precisely, the extrusion mixture was obtained by adding, to the extrusion mixture of example 1, the glass fraction of the composition given in Table 1 after fine grinding to obtain a fraction having grain size characteristics d₅₀=10 μm and d₉₀<60 μm. The mixture was adjusted so that the SiC/glass composition mass proportion was 75/25 in the final material.

In a manner similar to example 1, it was possible to obtain honeycomb monoliths, and also SiC rods, without difficulty, using the same conventional extrusion techniques. The monoliths and rods were sintered at a temperature of 1420° C. for 1 hour, that is, more than 700° C. below the normal temperature of R-SiC formation and with a much shorter firing time.

More precisely, the heat treatment was carried out in a conventional induction furnace under N₂ atmosphere in the following conditions: temperature rise of 20 K/min to 1420° C., then temperature holding for 1 hour at 1420° C., and finally descent at a rate of 20 K/min and then according to the inertia of the kiln.

### EXAMPLE 3

### According to the Invention

In a third step, another glass composition was prepared using the same technique as described in example 2, of fusion of a mixture of precursors, in suitable proportions, placed in platinum crucibles in an updraft kiln. After the complete fusion of the mixture, the glass was quenched in water to obtain a granulation.

The analysis shows that the glass phase thus obtained has the following composition, in molar percentage of the oxides:

TABLE 2

| SiO₂ | Al₂O₃ | CaO | MgO | Na₂O | BaO | B₂O₃ | ZrO₂ | Total |
|---|---|---|---|---|---|---|---|---|
| 47.61 | 21.54 | 11.12 | 0.18 | 0.27 | 12.98 | 3.86 | 2.45 | 100.00 |

An annealing of this vitreous phase at a temperature of 1000° C. served to confirm that it was possible to obtain, from this composition, a vitroceramic phase of which the crystalline phase is of the anorthite-celsian type (Bao—CaO—Al₂O₃—SiO₂ system).

Using the same techniques as in example 2, this glass composition was used, after fine grinding, to obtain extruded rods and honeycomb monoliths of the SiC-vitroceramic type according to the invention. An extrusion mixture was thereby obtained by mixing the same components as in example 1, but by adding to this mixture a fraction of the glass composition given in Table 2 after fine grinding to obtain a fraction having grain size characteristics d₅₀=10 μm and d₉₀<60 μm. The mixture was adjusted so that the SiC/glass composition mass proportion was 75/25 in the final material

In a similar manner to example 1 or 2, it was possible to obtain honeycomb monoliths, and also SiC rods, without difficulty, using conventional extrusion techniques. The monoliths and rods were sintered at a temperature of 1380° C. for 1 hour, that is, more than 800° C. below the temperature of R-SiC formation and with a much shorter firing time.

More precisely, the heat treatment was carried out in a conventional induction furnace under N₂ atmosphere in the following conditions: temperature rise of 20 K/min to 1380° C., then temperature holding for 1 hour at 1380° C. and finally descent in temperature at a rate of 20 K/min and then according to the inertia of the kiln.

The performance of the materials thus obtained and in particular their thermal shock resistance, an essential factor for use as a particulate filter in a motor vehicle exhaust line as described above, were evaluated by the TSP (Thermal Shock Parameter) criterion, conventionally used. In the technical field of ceramics, it is acknowledged that the TSP is representative of the thermomechanical strength of a material, in the sense previously described. More precisely, it is commonly acknowledged that the higher the TSP of a material, the better its thermomechanical strength.

More precisely, the TSP parameter is evaluated from the values of MoE, MoR and CTE according to the ratio TSP=MoR/(CTE×MoE), where:
MoR, expressed in Pa, is the bending modulus of rupture,
MoE, expressed in Pa, is the Young's modulus; and
CTE, expressed in 10⁻⁷/° C. units, corresponds to the thermal expansion coefficient of the material measured between 25 and 1000° C.
   The MoR was measured according to standard ASTM C1161-02.
   The MoE was measured by RFDA (Resonant Frequency and Damping Analyser) techniques. The measurement was taken according to standard ASTM C1259-94.

The apparent porosity and median pore diameter were measured on rods and extruded honeycomb monoliths by mercury porosimetry. The porosimetry results (apparent porosity and pore diameter) obtained appear to be substantially identical for the same material on the rods and the monoliths.

The main results of these measurements are given in Table 3 below.

TABLE 3

| | d₅₀ | Porosity | MoR | MoE | CTE | TSP |
|---|---|---|---|---|---|---|
| | (μm) | (%) | (MPa) | (GPa) | (×10⁻⁷/° C.) | (° C.) |
| Example 2 | 19.2 | 46.2 | 21.9 | 35.7 | 49 | 125 |
| Example 3 | 19.8 | 45.8 | 28.3 | 20.3 | 51 | 273 |
| R—SiC | 15.5 | 48.9 | 31.9 | 44.3 | 50 | 144 |
| (example 1) | | | | | | |

Table 3 shows that the TSP of the composite SiC/vitroceramic material of example 2 is approximately the same as the TSP of a R-SiC, reflecting a similar thermal shock resistance of the materials, although the SiC-vitroceramic material was obtained at a firing temperature at least 700° C. lower than that of the exclusively R-SiC material. The composite SiC/vitroceramic material of example 3 even has a better TSP factor than that of the R-SiC, for very similar porosity characteristics.

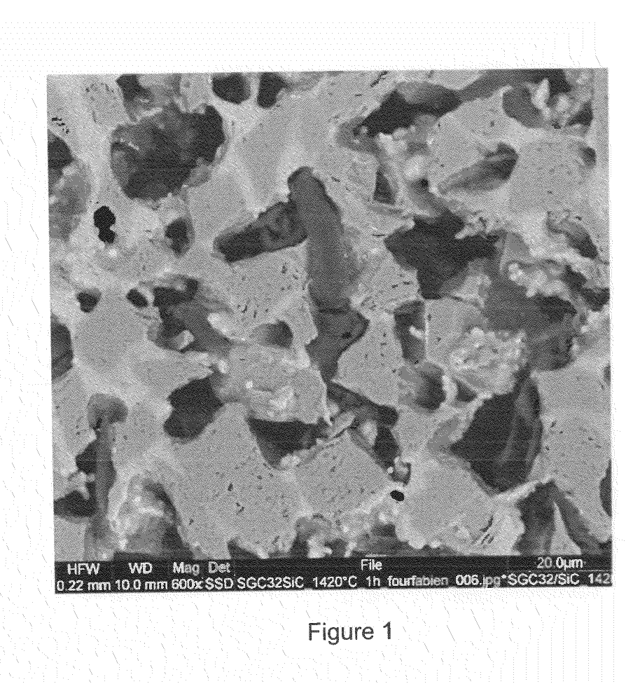

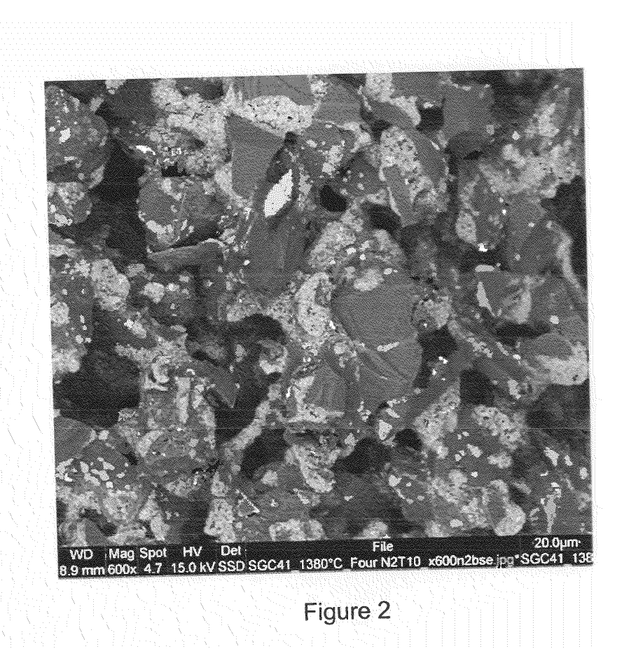

The microstructure of the materials was observed on SEM pictures in backscattered electron mode, shown respectively in FIG. 1 for example 2 and in FIG. 2 for example 3.

The pictures clearly show a porous 3D structure consisting of wide pores opening between the SiC grains. The pictures also show that the vitroceramic phase plays a bonding role between the SiC grains.

In the pictures (cf. FIGS. 1 and 2), the microstructure of the vitroceramics themselves can also be distinguished: in both cases, the interstitial phase between the SiC grains comprises an essentially crystalline phase, but with the presence of a residual vitreous phase around the polycrystalline clusters, the volume of said vitreous phase being about 5% and about 20% of the total volume of the vitroceramic phase.

The presence of a proportion of at least 5% by volume of the residual vitreous phase appeared to be preferable according to the invention, in order to impart to the product a “plastic” character at high temperature. Measurements of the Young's modulus as a function of temperature of the examples 2 and 3 showed a substantial decrease in the Young's modulus by comparison with the reference value measured on the exclusively R-SiC product: the thermal shock resistance is thereby improved.

### COMPARATIVE EXAMPLES

Other SiC/vitroceramic materials were also synthesized and analyzed, using a synthesis method identical to that of examples 2 and 3, but differing in the composition of the vitroceramic phase. In all cases, the TSP coefficient measured and calculated from the parameters MoE, MoR and CTE as previously described, is much lower than the reference value of R-SiC. The results are given in Table 4 below:

TABLE 4

| | Exam- | Exam- | Exam- | Exam- | Exam- | Exam- |
|---|---|---|---|---|---|---|
| | ple 4 | ple 5 | ple 6 | ple 7 | ple 8 | ple 9 |
| SiO₂ | 81 | 28 | 56 | 40 | 64 | 42 |
| Al₂O₃ | 14 | 45 | 4 | 47 | 30 | 10 |
| CaO | — | — | — | — | 2 | — |
| MgO | — | 24 | — | 12 | — | — |
| BaO | 4 | — | 39 | — | 3 | 47 |
| B₂O₃ | 1 | 3 | 1 | 1 | 1 | 1 |
| Total (mol %) | 100 | 100 | 100 | 100 | 100 | 100 |
| TSP (° C.) | <<100 | <<100 | <<100 | <<100 | <<100 | <<100 |

The results given in Table 4 show that none of the composite SiC-vitroceramic materials serves to obtain vitroceramic binders of which the TSP is close to that of SiC. Without proposing any theory whatsoever, one possible explanation would be that the vitroceramics of which the composition does not conform to the invention do not correctly play their bonding role between the SiC grains: the values of MoE and/or MoR are thus lower, and also that of TSP.

Other tests were also conducted on the composition of example 3 to measure the extent of the crystallinity rate of the vitroceramic phase:

### EXAMPLE 10

The holding time at the maximum firing temperature (1380° C.) was increased to 2 hours to reduce the crystallinity rate in the vitroceramic phase (temperature above the solidus). The vitroceramic has a crystalline volume, as estimated from the SEM pictures produced on the material obtained, lower than 80% of the total volume, that is, the residual vitreous phase accounts for more than 20% by volume. The measured TSP is accordingly much lower than 100, due to the significant decrease in the MoR.

1. A filter, comprising
a filtering portion comprising an inorganic material comprising grains of SiC bonded by a vitroceramic phase, to form a porous structure of with an apparent porosity between 20 and 70%,
said vitroceramic phase comprising, in molar percentage of total oxides present in said vitroceramic phase:
SiO₂: 30% to 80%;
Al₂O₃: 5% to 45%; and
MO: 10% to 45%,
wherein MO is an oxide of a divalent cation or a sum of oxides of divalent cations present in said vitroceramic phase, and
said vitroceramic phase has a volume percentage of residual vitreous phase lower than 20%.

2. The filter of claim 1, wherein the vitroceramic phase comprises between 40 and 60 molar % of SiO₂.

3. The filter of claim 1, wherein the vitroceramic phase comprises between 15 and 30 molar % of Al₂O₃.

4. The filter of claim 1, wherein the vitroceramic phase further comprises between 5 and 20 molar % of oxide A₂O in which A is an alkali or a sum of alkalis present in said phase, the alkali or alkalis being selected from the group consisting of Na, K, and Cs.

5. The filter of claim 1, wherein the vitroceramic phase further comprises between 1 and 5 molar % of boron oxide.

6. The filter of claim 1, wherein the mass ratio of the vitroceramic phase to the SiC is between 10/90 and 40/60.

7. The filter of claim 1, wherein the vitroceramic phase comprises, in molar percentage of the total oxides present in said vitroceramic phase:
SiO₂: 40% to 70%;
Al₂O₃: 10% to 30%; and
MgO: 15 to 35%.

8. The filter of claim 7, wherein the vitroceramic phase crystallizes in a cordierite structure, said vitroceramic phase comprising, in molar % of the oxides:
SiO₂: 40% to 55%;
Al₂O₃: 20% to 30%;
MgO: 18 to 30%; and
A₂O: 5 to 20%, wherein A is a monovalent cation; and
B₂O₃: 1 to 3%.

9. The filter of claim 1, wherein the vitroceramic phase crystallizes in an anorthite-celsian structure, said vitroceramic phase comprising, in molar % of the oxides:
SiO₂: 40% to 55%;
Al₂O₃: 15% to 30%;
CaO: 5 to 15%;
MO: 5 to 20%, wherein M is Ba and/or Sr; and
B₂O₃: 1 to 5%.

10. A motor vehicle exhaust component, comprising the filter of claim 1.

11. The motor vehicle exhaust component of claim 10, wherein the filter comprises a single monolithic element or is obtained by combining, by bonding with a joint cement, a plurality of honeycomb monolithic elements.

12. The filter of claim 1, wherein M is selected from the group consisting of Ca, Ba, Mg, and Sr.

13. The filter of claim 1, in which the vitroceramic phase comprises between 45 and 55 molar % of SiO₂.

14. The filter of claim 12, in which the vitroceramic phase comprises between 40 and 60 molar % of SiO₂.

15. The filter of claim 12, in which the vitroceramic phase comprises between 45 and 55 molar % of SiO₂.

16. The filter of claim 12, wherein the vitroceramic phase comprises between 15 and 30 molar % of Al₂O₃.

17. The filter of claim 2, wherein the vitroceramic phase comprises between 15 and 30 molar % of Al₂O₃.

18. The filter of claim 13, wherein the vitroceramic phase comprises between 15 and 30 molar % of Al₂O₃.

19. The filter of claim 14, wherein the vitroceramic phase comprises between 15 and 30 molar % of Al₂O₃.

20. The filter of claim 15, wherein the vitroceramic phase comprises between 15 and 30 molar % of Al₂O₃.
